(19) United States
(12) Patent Application Publication
(10) Pub. No.: US 2003/0173157 A1
(43) Pub. Date: Sep. 18, 2003

(54) Liquid delivery system and control system therefor

(76) Inventor: Gustav A. Lund, Phoenix, AZ (US)

Correspondence Address: RICHARD R. MYBECK, Post Office Box 5540, Scottsdale, AZ, 85258-5540, US

(21) Appl. No.: 10/099,490

(22) Filed: Mar. 13, 2002

(51) Int. Cl. F16N 11/10

(52) U.S. Cl. 184/29

(57) ABSTRACT

A new system of delivering a liquid such as lubricating oil from a source to a remote delivery point using a reciprocating pneumatic pump that is controlled by compressed gas diversion is presented. The control system is fabricated from air tubes which interconnect between valves. This system forces the piston in a reciprocating manner. The liquid is delivered by means of force induced by the compressed gas pump. A modified spring loaded pressure valve is required in the liquid supply line to assure correct operation of the system. The spring in the pressure valve is modified so that its restorative force is reduced by between about 30% and about 50%, and preferably reduced by about 40% of the force contained by the spring when manufactured.

### INTRODUCTION

The present invention relates generally to improved liquid delivery systems and control systems therefor, and more particularly to a system that delivers liquid from a reservoir to a desired delivery point through the use of an pneumatic pump whereby the delivery system is controlled by means of compressed gas inputs that actually drive the system.

### BACKGROUND OF THE INVENTION

As in any system, a liquid delivery system aims to combine operating efficiency with both reliability and low cost. Generally, control systems are also of increasing cost and complexity. The present invention is directed towards delivering a selected liquid to a desired point in a selected quantity at a designed flow rate. For a conceivable application of the present invention, possibly it could be worthwhile to consider the process of changing the motor oil in a gasoline or diesel engine powered motor vehicle. In pertinent part this process requires draining, and then replacing, the lubricating oil from the engine crankcase.

Purchase, packaging, transportation, and operating cost savings could be obtained if the example liquid, in this case lubricating oil, could be delivered in a bulk container, such as a 55-gallon drum, rather than the retail sized container regularly offered for sale. The principles of motion economy would also be respected if containers of lubricating oil did not have to be used at all. Ideally, the oil could then be delivered directly from the drum to the crankcase. This would likely involve a delivery rate in the approximate neighborhood of 1-10 gallons per minute “gpm”. Supplying liquid in this way has been attempted, albeit, to date, without great success. One mode of fluid delivery that has so far had unrealized potential is using a pneumatic pump to move liquid from either a supply point or reservoir to a delivery point such as the previously mentioned crankcase.

In the field of liquid delivery pumps, compressed air continues to be a popular means for driving the reciprocating motion of a pump piston. Usually, this involves a piston tube in which the piston is moved back and forth in response to alternating streams of inrushing compressed air, though of course any suitable gas or gas mixture could be used. In particular, air is forced to flow into the tube first on one side of the piston thus driving the piston in one direction. Then, at a preselected point, the first flow of air is halted, and a second flow is initiated on the opposite side of the piston, which forces the piston to move back in the direction from whence the piston originally came.

Then, when the piston is moved sufficiently in this second direction, the second flow is halted and a third flow is commenced which is identical in origin and action to the first flow to push the piston the same direction as the first flow did. As above, the third flow is ultimately halted and a fourth, identical to the second, is started. This cycle is then repeated over and over to reciprocate the piston and thereby drive the desired quantity of liquid, such as a lubricant, through the system to its preselected delivery point.

Conceptually this idea has appeal. To date, this concept has not worked in a totally satisfactory fashion. While there may be several causes for the lack of success to date, applicant believes that the “weakest link” of the system has been the pneumatic pump. This weakness may well have been compounded by the complicated mechanisms that have previously been used to control the pumping process.

A common concern with respect to pneumatically operated pumps involves the control of the alternating airflows in and out of the piston tube to drive the piston back and forth. Many prior art devices have made use of sliding members to effect the desired control of airflow into the respective chambers on either side of the piston. Examples of such prior art devices include those in current production by the Alemite Corporation, Charlotte, N.C.. Further, increasingly complex sliding (and the like) controls are disclosed in Hillis, U.S. Pat. No. 2,143,733; Scholle, U.S. Pat. No. 4,123,204; Dooley et al., U.S. Pat. Nos. 4,305,531, and 4,438,872; Stachowiak, U.S. Pat. No. 4,878,815; and Miller et al., U.S. Pat. No. 5,044,254. Even applicant has a complex geared pump that was thought to have solved the problem. Lund U.S. Pat. No. 6,152,706

In practice, such sliding control members suffer large amounts of friction due to the sliding contact and the requisite close tolerances necessary to seal the respective chambers. In part, this friction, and associated wear and tear may be due to the relatively high-pressure compressed air used thereby. This wear and tear also requires that the pumps be frequently overhauled at a relatively high cost. This is in direct conflict with the desiderata of low cost, reliability and operating efficiency. There also needs to be a control system that is reliable, relatively economical, has few moving parts, and is both safe and durable.

Thus, there remains a need to incorporate means and methods to alternately seal and unseal the pneumatic chambers of such pumps in a fashion, that will provide for extended part lives in the liquid delivery system, have a low capital cost, have relatively infrequent and inexpensive overhauls, and efficiently and repetitively deliver the desired liquid in a timely fashion. It is toward these desiderata that the present invention is primarily directed.

### BRIEF SUMMARY OF THE INVENTION

The present invention generally involves incorporating a pneumatically controlled reciprocating pump into a liquid delivery system. As is well known to the art, such pumps are attached to external supplies of a suitable compressed gas, most commonly air, although any suitable gas could be used. The gas choice would by dictated by the environment in which the pump was employed, conceivably a non-oxygen containing motive gas could be desirable.

To date, this system has been optimized for the delivery of motor lubrication oil. A suitable pump has been located. This pump is currently manufactured by SMC under the designation NCMB and has a front nose mounting. The pump presently found most suitable by the inventor has a bore of approximately 1 1/16-inch and a stroke of approximately 5 inches. As this pump is currently for sale, it is presumed to be known to those of ordinary skill in the art. The liquid delivery capacity of this pump approximates 3-6 gpm depending upon the precise stroke length selected. At this bore and in the range of air pressures used the flow rate of the pump in “gpm” is approximately equal to the stroke of the pump in inches.

The liquid, such as a paint or lubricant, is contained in a suitable storage container, such as a 55-gallon drum, or comes from a suitable supply source. The storage container is in fluid tight liquid communication with the pump. Likely the communication involves an inlet end of the supply tubing, securing means to ensure a fluid tight connection between the tubing and the source of the fluid, and affixing means to connect the outlet of the supply tubing to the inlet of the pump in a fluid tight manner.

The outlet end of the pump is connected to the inlet end of the delivery tubing. Remote actuation means are preferably in proximity to the outlet of the delivery tubing whereby the desired liquid is deposited where desired in the required quantity. The pump is actuated at the beginning of the delivery cycle, and de-activated when the desired amount of liquid has been delivered. Although the pump is styled a reciprocating pump for descriptive purposes, the cycle of the pump is likely not symmetrical, and the pump draws liquid into the system only on the upstroke portion of the cycle. A loose analogy would be a 2-stroke gasoline engine, although the stroke speeds need not be the same. As the downstroke portion of this cycle does not directly move the fluid, this portion of the cycle should be a relatively short as other design and operational considerations allow.

The operation of the pump, and the flow of the liquid, is regulated by a novel arrangement of pressure driven controls. These controls are driven by compressed air, and hence do not involve the use of either electric, or microprocessor controlled apparatus. The motion of the pump ram to designated points within the pump housing causes certain valves to diversion air into control tubing which is then connected to valves in the pump itself which cause the pump to change direction. During the interval between actuation, and de-actuation, the pump is controlled by use of the same compressed air that drives the pump, and thereby moves the desired liquid.

These controls do not require additional data input to operate, do not require user intervention once the pump has been assembled, yet positively control the operation of the device. These mechanical controls are reliable, relatively inexpensive, durable, and easy to maintain. Applicant is unaware of any similar control set.

Accordingly, a principal object of the present invention is to provide an improved liquid delivery system including a reciprocating pneumatic pump having a long wearing mechanism for controlling and directing air flow therethrough while delivering liquid from a reservoir to a delivery point.

Another object of the invention is to provide a system for delivering liquid at a desired location with reduced cost and enhanced reliability.

A further object of the invention is to provide a system wherein the liquid motive pump provides savings in both capital and operational/maintenance costs.

A further object of the present invention is to provide a mechanical pressure driven analog control system that enables the efficient delivery of liquid by means of the reciprocating pneumatic pump described herein.

These and still further objects as shall hereinafter appear are readily fulfilled by the present invention in a remarkably unexpected manner as will be readily discerned from the following detailed description of an exemplary embodiment thereof especially when read in conjunction with the accompanying drawings in which like parts bear like numerals throughout the several views.

### BRIEF DESCRIPTION OF THE DRAWINGS

In the drawings:

FIG. 1 is a view of the invention in use

FIG. 2 is a cut-away isometric view of the pump used in the present invention

FIG. 3 is a view of the pump control system

FIG. 4 is a cut away view of another portion of the pump.

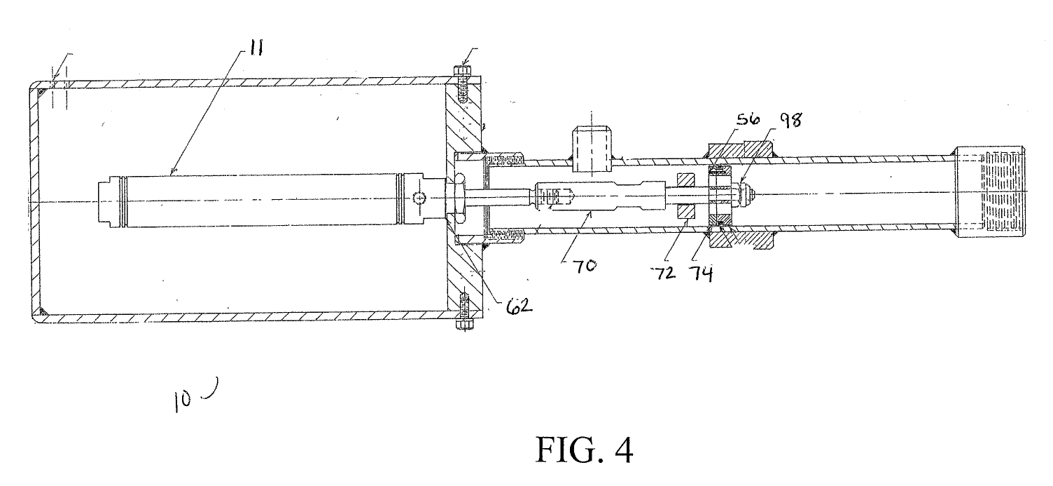

### DESCRIPTION OF THE PREFERRED EMBODIMENT

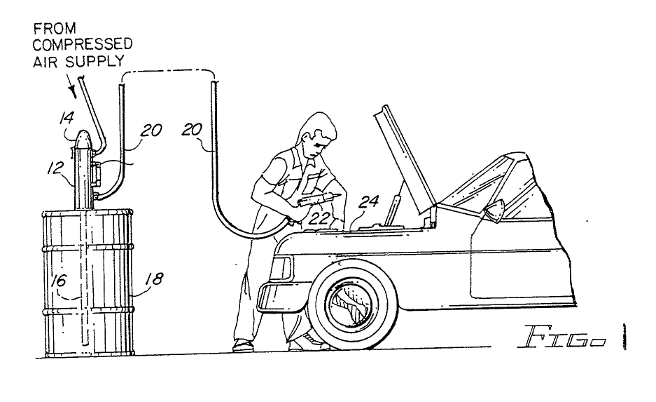

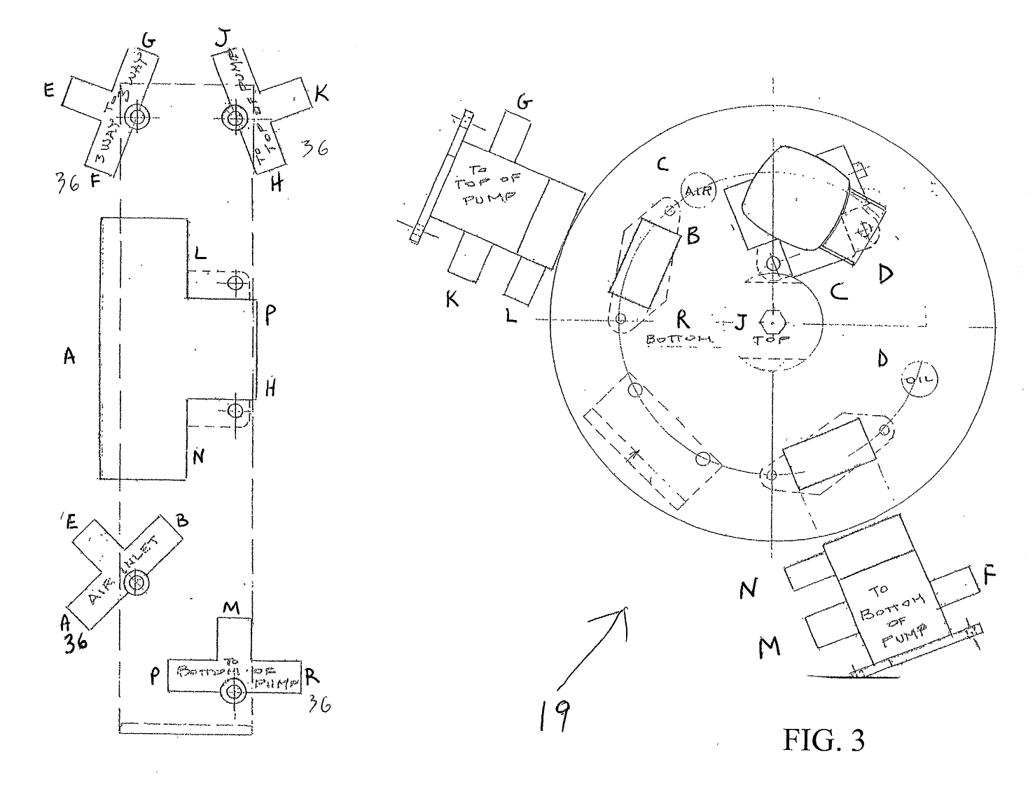

The present invention is a system that incorporates a pneumatic reciprocating pump for delivering a desired liquid, such as a lubricant to a desired delivery point, which is identified in the attached drawings by the general reference numeral 10. As shown in FIG. 1 the system 10 comprises a pump 11 inside a main piston housing or tube 12, a cap section 14 (housing 12 and cap 14 are the primary constituents in what is commonly known as an “air motor”) and a lubricant tube 16 which is insertable in a lubricant storage drum or barrel 18. The operation of the invention 10 is governed by control system 19 that is depicted in FIG. 3. As shown in FIG. 3 there are various reference letters A-R, excluding letters “I” and “O”. Each pair of like reference letters are connected in a manner described below. For letters A-E the connection must be as short as practical. The following pairs of connections must be as nearly the same lengths as possible: H-H and P-P; L-L and N-N; F-F and G-G; J-J and R-R; and, M-M and K-K.

A compressed gas source is operatively attached to the invention 10. Preferably this source provides compressed air, or suitable compressed gas, on demand, at a gage pressure no greater than about 55 psi, and preferably at a pressure of about 35-45 psi.

In one very useful application of system 10, shown in FIG. 1, a liquid such as motor oil is pumped from storage barrel 18 which contains the desired liquid through a hose 20 to and upon demand through a lubricant gun 22 for delivery into the crankcase 24 of a motor vehicle. Remote actuation means (not shown) is preferably attached to gun 22 in any suitable manner as is well known to those skilled in the art. Although not shown a standard bung adapter is a convenient way to assure that pump 11 is firmly attached to the exterior surface of down tube 16 to provide a standard sealable connection to barrel 18.

As is shown in FIG. 3 the operation of the system 10 is controlled by control system 19. The details of the control system 19 are discussed more fully below. As shown in FIG. 3 control system interacts with pump 11 by means of segments of preferably ¼ inch tubing (not shown), segments of preferably 5/32 inch tubing (not shown) that intersect at intersections 34 and are held in place through fasteners 36. The air tubes interact with the gas inlet and outlet valves to cause the reciprocating motion. Tube segments of ¼ inch diameter are used for the connections between letters A-D, H, J, P, and R. Tube segments of 5/32 inch diameter are used for the connections between letters E-N.

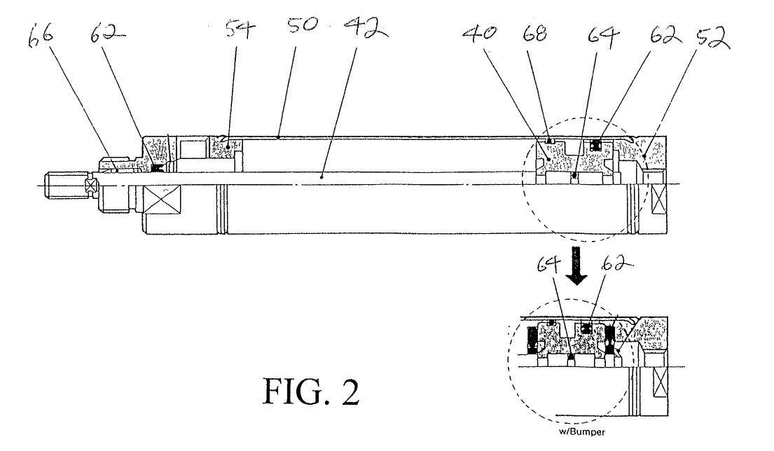

As shown in FIG. 2 the pump 11 is constructed in a manner well known to the art; the best such pump known to the inventor is pump NCMB manufactured by SMC corporation, having a 1 1/16 inch bore and a 5 inch stroke. At this dimension bore the flow rate producible by the pump, in gpm is approximately equivalent to the length in inches of stroke. As would be expected piston 40 is operatively connected to piston rod 42, which is of a length so as to provide the desired stroke. Pump 11 also comprises cylinder tube 50, head cover 52, rod cover 54, and pin 56 which is approximately ⅓ inch long and has a diameter of slightly less than 0.1 inch.

While cylinder tube 50 would usually be fabricated from stainless steel, the rod cover 54, head cover 52 and piston 40 would likely be fabricated from a suitable aluminum alloy. Piston rod 42 would likely be fabricated from low carbon steel with a moderate amount of manganese, such as ASTM grade 1018 carbon steel. The typical seals 62, gaskets 64, bushings 66 and wear rings are also employed to aid the operation of the invention 10.

A variety of inlet, outlet and control valves are employed in the operation of invention 10. These valves include two three-way valves 70, a four-way valve 72, and a pressure check valve 74. The configuration of valve 74 is critical to the successful operation of the invention 10. Applicant has determined that at present, a flapper type pressure valve does not allow the invention 10 to properly function. Therefore a spring loaded check valve must be employed.

Further, the standard spring provided with the pressure valve 74 is too strong and needs to have its restorative force reduced by approximately 30-40% of the force applied by the spring as manufactured. The preferred value is approximately 40% of this value. The best valve currently known to applicant is manufactured by NIBCO Inc., of Elkhart, Ind. and is an inline lift type, TFE seat and Resilient Disc, spring actuated class 125 threaded. bronze ring check valve.

As shown in FIG. 3, the air inlet to pump 11 is controlled by air carried by a tube segment that is also connected to the top of pump. Three segments of air tubing have only one connection within the control board. These air tubes are connected to the top of pump 11, the bottom of pump 11, and the compressed air source. .A typical, and suitable arrangement of the tubes is shown herein. Plainly any other arrangement could be used, and a more complex arrangement requiring more than two (2) three way valves 70 and one (1) four-way valve 72 could be employed.

The operation of the invention 10 is as follows. The remote actuation means is activated thereby supplying compressed air to the invention 10. Piston 40 is then forced to the down position if not already in that position. The compressed air then forces piston 40 into the up position, This suction causes the liquid to be removed from source 18. The pressure induced to upon the liquid is sufficient to overcome the resistive force in check valve 74. The liquid continues to flow until the compressed air is deactivated. At this point pump 11 ceases operation. This eliminates the pressure on the fluid. At this point the restorative force upon check valve 74 is sufficient to stop the flow of the liquid, and a fluid tight seal is reinstated.

The present invention offers several advantages over the prior art. The paramount advantage is reduced complexity and cost. The pump is simple and durable. Equally so is the control system which contains few complex moving parts. The same compressed gas inputs that drive the pump also drive the control system. Increasing, or decreasing the stroke of the piston can easily modify the flow rate of the invention.

As described herein, this system is optimized for lubricating oil as is used in gasoline and diesel engines. Other liquids having similar properties could also be used. This type of pump, and its control system, are particularly well suited for repetitive discrete, rather than continuous operations, though the present invention could be used for a continuous operation that employed the desired flow rates.

This system is designed to operate using compressed air, which is compressed from air at ambient temperatures. Applicant believes that the operation of the present invention could be enhanced through the use of essentially dry gasses such as are produced by commercial air compressors. The use of steam, in any way, would definitely appear to be contraindicated. Equally gasses such as nitrogen or carbon dioxide could also be employed in this invention if a reduced oxygen, oxidant free, or oxygen free environment were desired. The use of the word “air” as an adjective, or even as a noun, is to be understood as not precluding the use of other such gasses. However using such a gas could also impact other design choices described herein as they relate to the preferred embodiment of the present invention.

Further, in concept, liquids other than lubricating oil could be moved by the pump, depending upon the materials that the system is fabricated from. In addition, through the selection of the pump used, both capital and overhaul costs are greatly reduced when compared with currently existing systems.

From the foregoing, it is readily apparent that all of the aforestated objects have been fulfilled by the present invention in a remarkably unexpected fashion. it is of course understood that all modifications and alterations as may readily occur to the artisan having ordinary skill in the art to which this invention pertains are included within the present invention, which is limited solely by the scope of the claims appended hereto.

The following is claimed:

1. A low cost pneumatic system for delivering a liquid from a supply to a remote delivery point comprising:
a reciprocating pump driven by compressed gas
remote actuation means proximate said delivery point,
an automatic pneumatic control system that operates based on direct inputs from said compressed gas,
a liquid supply line that delivers said liquid from said supply to said delivery point where the pressure placed on said liquid in said line is supplied by said pump, and
a spring loaded pressure valve in said liquid supply line intermediate said supply and said delivery point having a suitable restorative force that maintains a fluid tight connection in the absence of said pressure supplied by said pump, but also allows said liquid to be readily delivered when said pressure is applied to said liquid by said pump.

2. A system according to claim 1 wherein said pump is actuated, said liquid is delivered at a flow rate of between 1 and 10 gpm.

3. A system according to claim 1 wherein said compressed gas has a pressure of less than about 55 psi.

4. A system according to claim 3 wherein said gas is air.

5. A system according to claim 4 wherein said compressed gas has a pressure of less than approximately 55 psi.

6. A system according to claim 5 wherein said compressed gas is supplied at a pressure of greater than about 25 psi.

7. A low cost pneumatic system for delivering a liquid from a source to a remote delivery point comprising:
a compressed gas driven pump having a piston, a cylinder top, and a cylinder bottom and gas inlet control valves,
remote actuation means proximate said delivery point,
an automatic pneumatic control system that operates based on direct inputs from said compressed gas so that gas diversion from when the said piston is in the up position proximate to said top of said cylinder switches said gas inlet control valves to force said piston into said down position proximate said bottom of said cylinder, and gas diversion from when said piston is in said down position switches said gas inlet control valves to force said piston into said up position
a liquid supply line that delivers said liquid from said source to said delivery point where the pressure placed on said liquid in said line is supplied by said pump, and
a spring loaded pressure valve in said liquid supply line intermediate said source and said delivery point having a restorative force that is sufficient to maintain a fluid tight connection in the absence of said pressure supplied by said pump, but is sufficiently small to allow said liquid to be readily delivered when said pressure is applied to said liquid by said pump.

8. A system according to claim 7 wherein said pump is actuated, said liquid is delivered at a flow rate of between 1 and 10 gpm.

9. A system according to claim 7 wherein said compressed gas is supplied at a pressure of less than 55 psi.

10. A system according to claim 9 wherein said gas is air.

11. A system according to claim 10 wherein said compressed gas is supplied at a pressure of less than 55 psi.

12. A system according to claim 11 wherein said compressed gas is supplied at a pressure of greater than about 25 psi.

13. A system according to claim 12 wherein said pump is manufactured by SMC corp. under the designation NCMB.

14. A system according to claim 13 wherein said liquid is lubricating oil.

15. A system according to claim 7 where said gas is an essentially dry gas.

16. A system according to claim 15 wherein the temperature of said gas is less than about 90 degrees Celsius

17. A system according to claim 7 wherein the length of the stroke of said piston is between about 3 and about 6 inches.

18. A system according to claim 7 wherein the bore of said pump is about 1 inch.

19. A system according to claim 17 wherein the bore of said pump is about 1 inch.
